(19) United States
(12) Patent Application Publication
(10) Pub. No.: US 2025/0096290 A1
(43) Pub. Date: Mar. 20, 2025

(54) METHOD FOR OPERATING A FUEL CELL SYSTEM, AND A CONTROL DEVICE

(71) Applicant: Robert Bosch GmbH, Stuttgart (DE)

(72) Inventors: Simon Buehler, Stuttgart (DE); Saskia Bostelmann, Stuttgart (DE); Tobias Falkenau, Esslingen (DE)

(21) Appl. No.: 18/729,310

(22) PCT Filed: Dec. 6, 2022
(86) PCT No.: PCT/EP2022/084605

§ 371 Date: Jul. 16, 2024

(30) Foreign Application Priority Data
Jan. 20, 2022 (DE) 10 2022 200 627.5

(51) Int. Cl. H01M 8/04664; H01M 8/04228; H01M 8/04303; H01M 8/0432; H01M 8/0438; H01M 8/0444; H01M 8/04537

(52) U.S. Cl. CPC H01M 8/04664; H01M 8/04228; H01M 8/04303; H01M 8/0432; H01M 8/04388; H01M 8/04455; H01M 8/04559

(57) ABSTRACT

The invention relates to a method for operating a fuel cell system (1) comprising a fuel cell stack (2) having a cathode (3) and an anode (4), wherein air is supplied to the cathode (3) via a supply air path (5), and exhaust air exiting the fuel cell stack (2) is discharged via an exhaust air path (6), and wherein the anode (4) is supplied with hydrogen via an anode circuit (7). According to the invention, when the fuel cell system (1) is switched off, the cathode (3) is shut off and the oxygen concentration of the air in the cathode (3) is minimized, and, when the system is subsequently restarted and the cathode (3) remains shut off, the following steps are then carried out:
a) the anode (4) is flushed with hydrogen,
b) at least one cell voltage and/or the total voltage of the fuel cell stack (2) is or are measured and used to detect a leakage point.

The invention also relates to a control device for carrying out steps of a method according to the invention.

### BACKGROUND

The invention relates to a method for operating a fuel cell system having the features of the disclosure. Furthermore, the invention relates to a control device which is set up to carry out steps of the method.

The method is particularly suitable for operating a mobile fuel cell system.

Hydrogen-based fuel cell systems are considered to be the mobility concept of the future, because they only emit water as exhaust gas and enable fast fueling times. In addition to hydrogen, fuel cells require oxygen to convert the hydrogen into electrical energy, heat, and water. To increase the electrical output, a large number of fuel cells are usually combined to form a fuel cell stack.

The core of a fuel cell is a membrane electrode assembly (MEA), which comprises a membrane coated on both sides with a catalytic material to form electrodes. During operation, one electrode, the anode, is supplied with hydrogen and the other electrode, the cathode, with air as an oxygen supplier. The hydrogen required can be stored in a tank.

As hydrogen is a flammable gas that can form an explosive mixture with air, hydrogen must be prevented from escaping from the fuel cell system. This means that leaks in the fuel cell system must be avoided or at least detected at an early stage. Leaks can occur if individual cells are damaged due to production, aging, and/or external influences. Another reason for leaks can be a valve that is stuck in the open position, for example a shut-off valve on the cathode or anode side that is stuck open and leaking, e.g., to interrupt the air supply to the cathode. The valve that is stuck in the open position and therefore leaking can also be a valve for blowing out the nitrogen and water on the anode.

Most fuel cell systems are sealed airtight by valves when switched off to prevent oxygen from entering the anode and damaging the membrane when restarted. In addition, when the fuel cell system is switched off, as much oxygen as possible that is still in the cathode is converted so that no or very little oxygen is present in the switched-off system. When restarting, the anode is first flushed with hydrogen, while the cathode is still kept sealed with the valves closed. This process is called “first flush.”

If the system is leaking, for example due to a valve that does not close tightly, air and therefore oxygen is drawn into the fuel cell stack during switch-off. During a prolonged switch-off phase, the oxygen can spread across the membrane by diffusion both in the anode and in the cathode. The larger the leak, the greater the amount of oxygen that enters the fuel cell stack.

A leak in the system therefore not only has the disadvantage that hydrogen can leak out of the anode area, but also that ambient air can penetrate the fuel cell stack and damage the individual fuel cells.

### SUMMARY

The present invention is based on the task of enabling leakage detection during operation of a fuel cell system in order to avoid the disadvantages described above. Leaks should be detected as early as possible.

In order to solve this problem, the method having the features of the disclsoure is proposed. A control device for carrying out steps of the method is also specified.

A method of operating a fuel cell system comprising a fuel cell stack with a cathode and an anode is proposed. Air is supplied to the cathode via a supply air path and exhaust air leaving the fuel cell stack is discharged via an exhaust air path. The anode is supplied with hydrogen via an anode circuit. According to the invention, when the fuel cell system is switched off, the cathode is shut off and the oxygen concentration of the air present in the cathode is minimized. The following steps are then carried out when the system is restarted and the cathode is still shut off:
the anode is flushed with hydrogen,
at least one cell voltage and/or the total voltage of the fuel cell stack is/are measured and used to detect a leakage point.

The build-up of voltage requires the presence of oxygen. However, if the cathode was shut off during switch-off and any oxygen present in the cathode was removed, for example by transferring the oxygen, there will be a lack of oxygen when restarting or during the first flush. If a voltage nevertheless builds up, this is an indication of a leak or a leak in the system.

The disadvantage that air and thus oxygen is drawn in when there is a leak proves to be an advantage for the proposed method. This is because if the system is leaking, air and therefore oxygen is drawn in during the switch-off phase, so that a voltage is applied across the fuel cells during the first flush of the anode. The voltage applied is proportional to the amount of oxygen present. As even small amounts of oxygen can be detected by the voltage, leakage points can be detected at an early stage. No additional measurement technology is required.

As the hydrogen supply to the anode is disconnected or the anode is also “shut off” when the system is switched off, the voltages indicating a leak only build up when the system is restarted, i.e., during the first flush.

When the anode is first flushed with hydrogen, the voltage depends on how much oxygen is present on the cathode side of the individual fuel cells. This does not mean that the leak must necessarily be on the cathode side. This is because oxygen can spread in the fuel cell stack by diffusion, in both directions, i.e., from the cathode side to the anode side and vice versa. The leak does not necessarily have to be in the fuel cell stack, but can be anywhere in the system.

Since any measured voltage indicates a leakage, the voltage can be recorded individually for each cell and/or over the entire stack when carrying out the proposed method.

Advantageously, the size of a detected leakage point is estimated using the at least one measured cell voltage and/or the total voltage. Since the measured voltage is proportional to the amount of oxygen in the cathode, the measured voltage can be used to quantify the leakage. In this way, a leakage assessment mechanism can be installed.

When estimating the size of a detected leakage point, the duration of the previous switch-off phase is preferably taken into account. This is because the longer the switch-off phase lasts, the more air and therefore oxygen is drawn in via the leakage point. The size of the leakage point can therefore be estimated more accurately.

Alternatively or additionally, it is proposed that the temperature in the fuel cell stack at the start of the switch-off phase be taken into account when estimating the size of a detected leakage point. When the fuel cell system is switched off, a vacuum is created which encourages air to be drawn in via a leak. The negative pressure depends on the temperature. The temperature at the start of the switch-off phase can therefore be used to determine the pressure or negative pressure in the fuel cell stack and thus the amount of air or oxygen drawn in. By taking into account the temperature at the start of the switch-off phase and thus the pressure or negative pressure in the fuel cell stack, the size of the detected leakage point can be estimated even more accurately.

During longer switch-off phases, the oxygen drawn in with the air spreads by diffusion across the membrane both in the anode and in the cathode. By measuring the cell voltages of individual fuel cells and/or fuel cell groups, the voltage distribution across the fuel cell stack can be determined. The voltage distribution can in turn be used to determine the location of the leakage point, as the voltage distribution correlates with the distribution of oxygen in the fuel cell stack.

As an additional measure, it is therefore proposed that a leakage point be detected and localized based on the voltage distribution across the individual fuel cells in the fuel cell stack. The voltage distribution shows where air or oxygen enters the system and then spreads by diffusion. For example, the voltage distribution can be used to identify whether the leakage point is a leaking cell or a leaking valve.

A leaking valve can be identified in the same way. Since the spread of oxygen in the system depends on the length of the flow path that extends from the leaking valve to the respective individual cell, a characteristic oxygen distribution over the individual fuel cells results for each leaking valve. If hydrogen is then blown in on the anode side during the first flush, a voltage proportional to the oxygen present is formed in the corresponding cells. This results in a characteristic distribution of cell voltages for each leaking valve, which can be used to identify the leaking valve. If a leaking valve is identified, a corresponding error message can be set and reported back. By identifying the leaking valve, the corresponding valve can then be replaced in the workshop in a targeted manner, saving the costs and time for the otherwise necessary inspections.

Preferably, the duration of the previous switch-off phase and/or the temperature at the start of the switch-off phase are taken into account when localizing a leakage point. This is because both parameters have an influence on the oxygen distribution in the fuel cell stack. If they are taken into account, a leakage point can be localized very precisely.

Preferably, the at least one cell voltage and/or the total voltage is or are monitored with the aid of a control device. In particular, this may be the control device of the fuel cell system. The control device can be used to set up leakage monitoring, which is activated when the fuel cell system is started after a longer switch-off phase, for example several hours. Furthermore, preferably at least one time-dependent voltage distribution is stored in the control device, which is characteristic for a specific valve of the fuel cell system when it is leaking. If the valve leaks during operation of the fuel cell system, the characteristic voltage distribution stored in the control device can be used to directly identify the leaking valve.

It is further proposed that the method steps a) and b) serving to detect a leakage are carried out repeatedly, preferably each time the fuel cell system is started after a longer switch-off phase, in particular lasting several hours, and the at least one measured cell voltage and/or total voltage is or are stored. The stored voltage values can be used to record relevant changes, such as whether a leakage point has increased in size and/or a new leakage point has formed. In this way, compliance with a tightness limit value can be monitored. If the limit value is exceeded, countermeasures can be taken.

In addition, a control device that is configured so as to carry out steps of the method according to the invention is proposed. The control device can be used to automate leakage monitoring.

### BRIEF DESCRIPTION OF THE DRAWINGS

The invention and its advantages are explained in more detail below with reference to the accompanying drawings. Shown are:

FIG. 1 is a schematic representation of a fuel cell system that can be operated according to the method of the invention,

FIG. 2 a) Voltage curve over time t during the first flush after a switch-off phase of several hours and with the cathode shut off and free of oxygen, b) Voltage distribution over the individual cells three seconds after the start of the first flush,

FIG. 3 a) Voltage curve over time t during the first flush after a switch-off phase of several hours and with the cathode shut off, wherein a valve was left open to simulate a leakage point, b) Voltage distribution over the individual cells three seconds after the start of the first flush,

FIG. 4 a) Voltage curve over time t during the first flush after a switch-off phase of several hours and with the cathode shut off, wherein another valve was left open to simulate a leakage point, b) Voltage distribution over the individual cells three seconds after the start of the first flush, and

FIG. 5 a) Voltage curve over time t during the first flush after a switch-off phase lasting several hours and with the cathode shut off, wherein two valves were left open to simulate leakage points, b) Voltage distribution over the individual cells three seconds after the start of the first flush.

### DETAILED DESCRIPTION

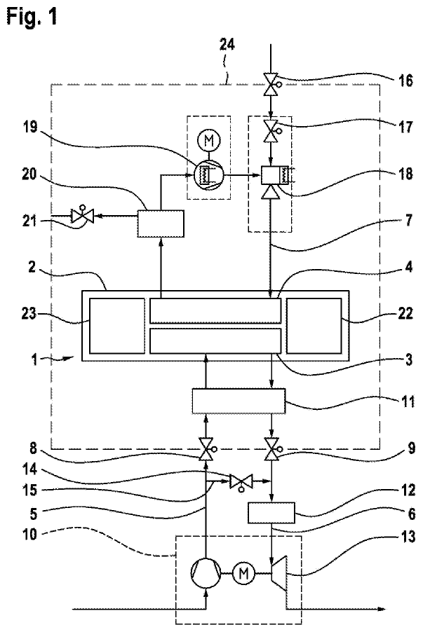

FIG. 1 shows an example of a fuel cell system 1 with a fuel cell stack 2, which has a cathode 3 and an anode 4. The fuel cell stack 2 is connected to a cooling circuit 22 in order to dissipate the heat generated in the process. Furthermore, at least one electrical connection 23 is provided.

During operation of the fuel cell system 1, air is supplied to the cathode 3 as an oxygen supplier via a supply air path 5. An air conveying and air compression system 10 is integrated into the supply air path 5, with the help of which the air is compressed in advance. A humidifier 11 is also provided, which can be used to humidify the air in advance. Exhaust air leaving the fuel cell stack 2 is discharged via an exhaust air path 6. A turbine 13 of the air conveying and air compression system 10 is integrated into the exhaust air path 6 for energy recovery. Before the exhaust air is fed to the turbine 13, liquid water is removed from the exhaust air with the aid of a water separator 12. In addition, several valves 8, 9 are provided on the cathode side to shut off the cathode 3 in the event of switch-off, as well as a bypass valve 14 integrated into a bypass path 15 to bypass the fuel cell stack 2.

The anode 4 is supplied with hydrogen from a high-pressure tank (not shown) via an anode circuit 7 and by means of recirculation. When hydrogen is withdrawn from the high-pressure tank, the pressure is first reduced with the aid of a pressure reducer 16. The hydrogen is then metered into the anode circuit 7 with the aid of a metering valve 17 in the area of a jet pump 18. The jet pump 18 is activated by the quantity of hydrogen injected. It is used for the passive recirculation of depleted hydrogen that escapes from the fuel cell stack 2. A blower 19 is also provided for active recirculation. In order to remove liquid water from the recirculate, a further water separator 20 is connected upstream of the blower 19, which can discharge the separated water via a drain valve 21. As the recirculate accumulates nitrogen over time, the anode circuit 7 must be flushed from time to time. For this purpose, another valve can be opened, the so-called purge valve (not shown), so that part of the anode gas is discharged from the anode circuit 7 and replaced by fresh hydrogen. Alternatively, the purge function can be integrated into the drain valve 21 so that a separate purge valve is not required.

Since hydrogen escaping from the fuel cell system 1 can form an explosive gas mixture, increased tightness requirements are placed on the hydrogen-carrying area. The hydrogen-carrying area or sealing area 24 is indicated by a dashed line in FIG. 1. Leaks can be caused in particular by valves sticking in the open position. In addition, leaks can form due to aging or wear and/or damage. These must be recognized and eliminated if necessary. The proposed method according to the invention serves this purpose.

To detect a leak, the voltage is measured after a longer switch-off phase of several hours during the first flush, i.e., when restarting with the cathode shut off. If a voltage can be measured, this is an indication that oxygen is present on the cathode side. Since the cathode should be properly shut off, only a leakage can be the reason for the presence of oxygen. As the voltage distribution correlates with the oxygen distribution in the stack, the leakage point can be localized at the same time.

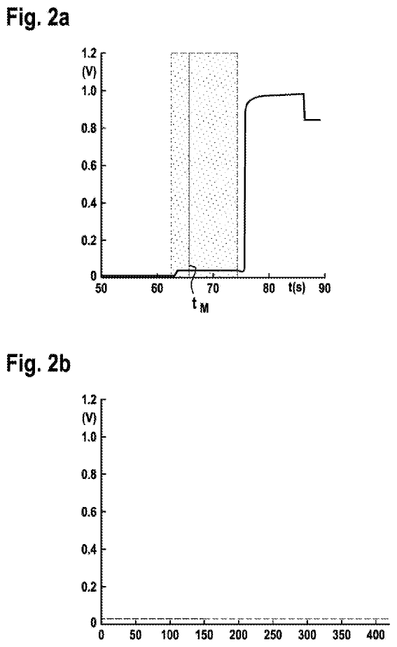

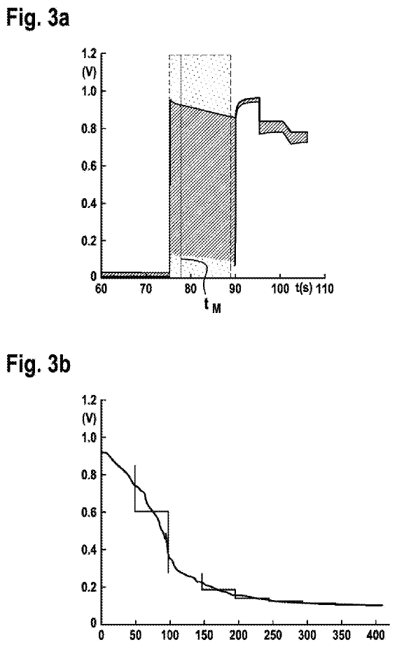

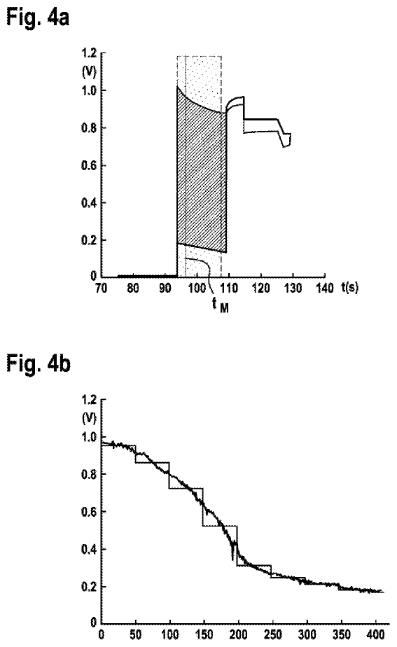

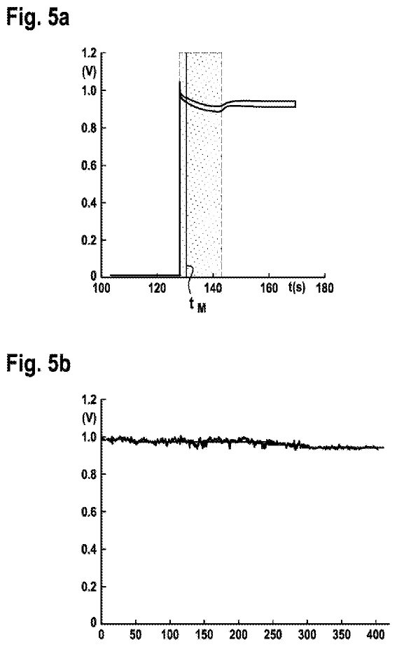

FIGS. 2a) through 5a) show examples of different voltage curves that were measured after a seven-hour switch-off phase during the first flush, namely with closed valves (FIGS. 2a)) and with one or more open valves (FIGS. 3a) through 5a)) to simulate a leak. The gridded area represents the period of the first flush. The respective voltage distribution is shown in FIGS. 2b) through 5b), in each case at time t_{M}. This is three seconds after the start of the first flush. It can be seen that the voltage distribution differs depending on which valve or valves are open. As a result, the leaking valve can be identified via the voltage distribution.

1. A method for operating a fuel cell system (1) comprising a fuel cell stack (2) having a cathode (3) and an anode (4), wherein air is supplied to the cathode (3) via a supply air path (5), and exhaust air exiting the fuel cell stack (2) is discharged via an exhaust air path (6), and wherein the anode (4) is supplied with hydrogen via an anode circuit (7),
wherein when the fuel cell system (1) is switched off, the cathode (3) is shut off and the oxygen concentration of the air in the cathode (3) is minimized, and, when the system is subsequently restarted and the cathode (3) remains shut off, the following steps are then carried out:
a) the anode (4) is flushed with hydrogen,
b) at least one cell voltage and/or the total voltage of the fuel cell stack (2) is or are measured and used to detect a leakage point.

2. The method according to claim 1,
wherein the size of a detected leakage point is estimated based on the at least one measured cell voltage and/or the total voltage.

3. The method according to claim 2,
wherein the duration of the preceding switch-off phase and/or the temperature in the fuel cell stack (2) at the beginning of the switch-off phase is or are considered when estimating the size of a detected leakage point.

4. The method according to claim 1,
wherein the voltage distribution across the individual fuel cells of the fuel cell stack (2) is used to detect and locate a leakage point.

5. The method according to claim 4,
wherein the duration of the preceding switch-off phase and/or the temperature in the fuel cell stack (2) at the beginning of the switch-off phase is or are considered when locating a leakage point.

6. The method according to claim 1,
wherein the at least one cell voltage and/or the total voltage is or are monitored with the aid of a control device, wherein at least one time-dependent voltage distribution is preferably stored in the control device, which voltage distribution is characteristic of a specific valve (8, 9) when the latter is leaking.

7. The method according to claim 1,
wherein the method steps a) and b) for detecting a leakage are carried out repeatedly, preferably each time the fuel cell system is started after a switch-off phase lasting several hours, and the at least one measured cell voltage and/or total voltage is or are stored.

8. A control device configured to perform steps of a method according to claim 1.
